(19) United States
(12) Patent Application Publication
(10) Pub. No.: US 2010/0112060 A1
(43) Pub. Date: May 6, 2010

(54) FORMULATIONS OF ENTOMOPATHOGENIC FUNGI FOR INSECT CONTROL

(76) Inventors: Pesah Maor, Kfar Tabor (IL); Gregory Pipko, Katzrin (IL); Ofer Kleifeld, M.p. Hamovil (IL)

Correspondence Address: FENNEMORE CRAIG, 3003 NORTH CENTRAL AVENUE, SUITE 2600, PHOENIX, AZ, 85012, US

(21) Appl. No.: 12/515,598

(22) PCT Filed: Nov. 21, 2007
(86) PCT No.: PCT/IL07/01440

§ 371 Date: Jan. 4, 2010

Related U.S. Application Data
(60) Provisional application No. 60/860,212, filed on Nov. 21, 2006.

(51) Int. Cl. A01N 25/02; A01N 63/04

(52) U.S. Cl. 424/484; 424/93.5

(57) ABSTRACT

The present invention describes insecticidal compositions comprising spores of entomopathogenic fungi suspended in oil in water emulsions comprising fatty acid salts, polyhydric alcohols, and additional emulsifiers. A method of producing such emulsions is presented. Methods for use of the compositions for preventing and controlling insect infestation in animals and natural areas, particularly tick infestations, are disclosed.

### FIELD OF THE INVENTION

The present invention relates to the use of entomopathogenic fungi in formulations for topical and environmental insect control, particularly to the use of viable spores of entomopathogenic fungi in an oil-in-water emulsion.

### BACKGROUND OF THE INVENTION

Ticks are ectoparasites feeding on animals and humans. Ticks are prevalent in the tropical and subtropical areas and are usually active seasonally, mostly from spring through the autumn. The most commonly identified species on domestic pets and cattle belong mainly to ixodids, genera such as: Ixodes, Rhipicephalus, Dermacentor, Hyalomma and Boophilus. All ticks species develop via four stages, the embryonated egg, followed by the three active stages, known as the larval, nymphal and adult stages. The length of the life cycle can vary considerably, from less than six months for Rhipicephalus genus up to three years for Ixodes genus. In most species, each active stage seeks a new host, feeds, and drops off to develop in the natural environment.

Ticks are known to be vectors of pathogenic organisms such as viruses, bacteria, and rickettsia. Tick-born diseases include Lyme disease, Rocky Mountain Spotted Fever, Mediterranean Spotted Fever, Theileriosis, Babesiosis, Ehrlichiosis, Tick-born Encephalitis, Tick Paralysis, and other diseases. Some of these diseases can be fatal if left untreated.

Ticks can cause a direct economical impact because of a general loss of host condition due to irritation, anemia, secondary infection, paralysis, and toxicosis. However, their major impact upon cattle production is their ability to vector a wide spectrum of pathogenic microorganisms. Disease transmitted by ticks is a major factor in limiting cattle production in many subtropical and tropical regions of the world. Research shows that the effect of ticks on beef and dairy products is significant. For example, studies show that infested cows produce less milk and gain less weight compared to tick-free cows. Likewise, it is estimated that tick control would greatly increase beef production in tick-enzootic regions.

Currently, most prevalent solutions against ticks are compositions based on synthetic chemicals. Numerous synthetic pesticides are used for tick control in animals. Chemical pesticides with acaricidal properties are described for example in U.S. Pat. Nos. 3,864,497, 5,045,536, 5,194,264, 6,001,384, 6,010,710, 6,413,542, 6,426,333, 6,482,425, 6,683,876, 6,844,369, 6,875,885, 6,905,699, 6,906,108, and 7,091,233 among many others.

The two main drawbacks of synthetic chemical products in the control of ticks are the ticks' resistance to the active substances used in these products, which results from the rapid and constant development of new mutations; and the toxic effects of synthetic chemicals on human beings, animals, and the environment.

Due to these concerns, there is increased interest in the development of effective alternatives that pose no risk to human and animal health and to the environment, such as biological control programs. Such programs include, for example, tick vaccines, pasture rotation, destruction of the tick habitat, breeding of resistant cattle, and the use of entomopathogenic fungi that kill ticks.

Over 700 species of entomopathogenic fungi have been reported, but only 10 species have been or are currently being developed for the control of insects. The most promising fungi are from the class Deuteromycetes (imperfect fungi), particularly from the species Metarhizium anisopliae and Beauveria bassiana.

The fungal spores germinate on contact with the cuticle of the insect, produce a penetration germ tube and establish a systemic infection that kills the host within several days.

The ability of entomopathogenic fungi to kill several stages of the same pest, and their relatively specific virulence to one or a small group of pests, make them ideal candidates as biocontrol agents. However, fungi also have some disadvantages: they are slow in killing their hosts, they need high humidity to germinate, and they are susceptible to UV irradiation. Mass production can be quite costly and the limited shelf life of some products makes them even more expensive.

Several methods of using fungal insecticides (mycocides) are known. U.S. Pat. No. 5,804,208 describes the preparation of mycocides consisting of semolina grains coated with M. anisopliae spores to control pests. The preparation of carrier-free fungal cell granulates is described in U.S. Pat. No. 5,418,164. Several devices known as infection chambers for insects, designed to attract insects and containing live infective fungi, including M. anisopliae and B. bassiana, are described in U.S. Pat. Nos. 5,983,558, 5,679,362, 5,427,784, 5,189,831, and 5,057,316. U.S. Pat. No. 6,261,553 discloses the use of entomopathogenic fungus virulent against insects of the grasshopper family. That patent particularly discloses the use of Beauveria bassiana against such insects.

Other preferred methods of tick control involve the use of aqueous suspensions of fungal spores. The hydrophobic nature of the spores, however, may cause clotting and aggregation when they are mixed within an aqueous solution. This non-homogeneous dispersion of the spores reduces its efficiency and ease of application. Compositions containing compounds such as oils or emulsifiers are being developed to overcome this problem. In laboratory assays, M. anisopliae and B. bassiana spores suspended in oil in water emulsions are more effective than water suspensions of spores (Polar et al., 2005, Mycopathologia, 160:151-7). To the best of our ability to ascertain, as of to date compositions of entomopathogenic fungi and oil in water or water in oil emulsions have never been assayed to treat tick infections in farm animals or domestic pets.

US Application Publication Nos. 20050084545 and 20050175714 to one of the inventors of the present invention and co-workers discloses fungicidal oil in water compositions comprising tea tree oil and alkali salts of organic fatty acids, and methods of producing said compositions. The tea tree oils are the fungicidal ingredient in these compositions.

Clearly, the formulation in which the spores are applied is crucial to the level of control obtained using fungus-based anti-tick compounds (Samish et al., 2004, Parasitology, 129 Suppl.:S389-403; Polar et al., 2005 Mycopathologia, 160:151-7; Maranga et al., 2005 Mycopathologia, 159:527-32).

The interest in biological control of ticks and other pests is growing because pests are becoming increasingly resistant to acaricides and pesticides. There is a rising demand for safer veterinary and pharmaceutical products and chemical-free agriculture. Thus, there is an unmet need for an effective biological pest control agent that is safe and convenient to use.

### SUMMARY OF THE INVENTION

The present invention provides compositions comprising a fungal control agent useful in biological control of insects. More specifically, the present invention provides compositions comprising viable spores of entomopathogenic fungi suspended in oil in water emulsions, effective in preventing and controlling insect infestations, wherein insects include but are not limited to ticks, beetles, fleas, mites, and lice. The composition can be formulated as a sprayed emulsion, paste, wettable powder, dust, or shampoo. The composition may be applied directly to the animal, to its living environment, or to the natural environment. The present invention is particularly directed towards preventing and controlling infestations caused by ticks.

The present invention discloses oil in water emulsions comprising organic oils, alkali or ammonium salts of organic fatty acids as main emulsifiers, one or more co-emulsifiers and a polyhydric alcohol that is suitable for suspension and dispersion of viable spores of fungi. In some embodiments the emulsion further comprises a dispersing additive.

The present invention is based in part on the unexpected finding that the abovementioned emulsions are not fungicidal, thus enabling their use in compositions comprising viable spores of entomopathogenic fungi to provide a biological pest control product. The components of the composition are selected to protect the spores from solar degradation and low humidity, and to enhance thermal stress tolerance, thereby allowing effective maintenance, transport, and administration conditions of the compositions.

The present invention accordingly provides a composition comprising viable spores of entomopathogenic fungi and said emulsions. Spores of Metarhizium anisopliae are used in some exemplary embodiments.

The present invention also discloses bioassays and field trials of the effectiveness of the compositions on ticks and lice. Results show that the compositions are more effective than known compositions containing spores.

The properties of these formulations provide unique advantages for a biocompatible insect biocontrol product that is environmentally friendly and easily administered.

One aspect of the present invention relates to a composition comprising viable spores of at least one entomopathogenic fungus and an oil in water emulsion comprising at least one organic oil, at least one sodium, potassium, or ammonium salt of an organic fatty acid, at least one emulsifying agent, and at least one polyhydric alcohol.

The organic oils used in the emulsion include, but are not limited to: olive oil, soya oil, corn oil, sunflower oil, canola oil, linseed oil, castor oil, fish oil, tung oil, sesame oil, and middle chain triglyceride (MCT) oils.

According to some embodiments of this aspect of the present invention, the oil concentration in the emulsion ranges from 12% to 30% by weight. In currently preferred embodiments, the oil concentration ranges from 15% to 25% by weight.

Organic fatty acids used in the emulsion include, but are not limited to: oleic acid, lauric acid, myristic acid, arachidic acid, linoleic acid, linolenic acid, decenoic acid, dodecenoic acid, tall oil fatty acids, naphthenic acids, stearic acid, and palmitic acid.

Emulsifying agents used in the emulsion include, but are not limited to: Triton X100, Tween 20, Tween 80, and lauryl amide. In typical embodiments the emulsion comprises at least two emulsifying agents. In currently preferred embodiments, the emulsifying agents are Tween 20 and lauryl amide. In some embodiments, the concentration of the emulsifying agent ranges from 0.3% to 5% by weight. In currently preferred embodiments, the concentration of the emulsifying agent ranges from 0.6% to 3% by weight.

Polyhydric alcohols used in the emulsion include, but are not limited to: ethylene glycol, propylene glycol, and glycerol. In currently preferred embodiments, the polyhydric alcohol is glycerol. In some embodiments, the concentration of polyhydric alcohol ranges from 8% to 30% by weight. In currently preferred embodiments, the concentration of polyhydric alcohol ranges from 10% to 25% by weight.

In certain embodiments of the present invention, the composition further comprises a dispersing additive. In currently preferred embodiments, the dispersing additive is BYK 980® (BYK Chemie, Wesel, Germany).

According to some embodiments of this aspect of the present invention, the fungus is selected from the group consisting of Metarhizium anisopliae and Beauveria bassiana. In currently preferred embodiments, the fungus is Metarhizium anisopliae strain Ma7 or Metarhizium anisopliae strain MITM1, deposited with the American Type Culture Collection Association (ATCC) under Accession No. ______.

Another aspect of the present invention relates to a method for preventing or treating an insect infestation comprising applying an effective amount of a veterinary composition comprising viable spores of at least one entomopathogenic fungus and an oil in water emulsion comprising at least one organic oil, at least one sodium, potassium, or ammonium salt of an organic fatty acid, at least one emulsifying agent, and at least one polyhydric alcohol.

In some embodiments, the composition is prepared by admixing the fungal spores and the emulsion extemporaneously to the application. In alternative embodiments, the composition is prepared by admixing the fungal spores and the emulsion substantially prior to the application.

In some embodiments, the composition is formulated as an emulsion, a suspension, a powder, a paste, or a shampoo.

In some embodiments, the composition is applied topically to the skin of an animal. In other embodiments, the composition is applied to the animal's environment. In yet other embodiments, the composition is applied to open areas such as pastures.

In certain embodiments, the composition is applied manually, or applied with a hand sprayer, a race sprayer, or sprayed from an airplane.

According to some embodiments of this aspect of the present invention, the fungus is selected from the group consisting of Metarhizium anisopliae and Beauveria bassiana. In certain currently preferred embodiments, the fungus is Metarhizium anisopliae strain Ma7 or Metarhizium anisopliae strain MITM1.

In other preferred embodiments of this aspect of the present invention, the infestation being treated is caused by ticks, beetles, fleas, mites, or lice. In a more preferred embodiment, the infestation being treated is a tick infestation.

Another aspect of the present invention relates to a kit for preventing or treating an insect infestation comprising: packaging material, viable spores of at least one entomopathogenic fungus, and an oil in water emulsion, wherein the emulsion comprises at least one organic oil, at least one sodium, potassium, or ammonium salt of an organic fatty acid; at least one emulsifying agent; and at least one polyhydric alcohol.

According to some embodiments, the spores and the emulsion are packed in the same container. In preferred embodiments, each of the spores and the emulsion is packed in a separate container.

In some embodiments, the fungus is selected from the group consisting of Metarhizium anisopliae and Beauveria bassiana. In certain currently preferred embodiments, the fungus is Metarhizium anisopliae strain Ma7 or Metarhizium anisopliae strain MITM1. In yet other currently preferred embodiments, the fungus is M. anisopliae, designated MITM1, deposited with the American Type Culture Collection Association (ATCC) under Accession No. ______.

In some embodiments, the insect infestation being treated is caused by ticks, beetles, fleas, mites, or lice. In certain currently preferred embodiments, the infestation being treated is a tick infestation.

Another aspect of the present invention relates to an oil in water emulsion comprising: at least one organic oil, at least one organic fatty acid salt; at least one emulsifying agent; and at least one polyhydric alcohol. In certain embodiments the emulsion further comprises a dispersing additive.

Yet another aspect of the present invention relates to a method of making an oil in water emulsion comprising: at least one organic oil, at least one sodium, potassium, or ammonium salt of an organic fatty acid; at least one emulsifying agent; and at least one polyhydric alcohol.

According to some embodiments, said method comprises the following steps:
admixing an aqueous solution of a sodium, a potassium, or an ammonium compound with a mixture of an organic fatty acid and an organic oil to obtain a first composition;
(ii) adding a polyhydric alcohol and an emulsifying agent to the composition obtained in step (i); and
(iii) mixing until an oil in water emulsion is obtained.

In other embodiments, step (ii) further comprises adding a dispersing additive.

The dispersing additive is BYK 980® in typical embodiments.

In some embodiments the sodium, potassium, or ammonium compound is selected from the group consisting of: sodium hydroxide, potassium hydroxide, sodium carbonate, potassium carbonate, sodium bicarbonate, potassium bicarbonate, ammonium hydroxide, ammonium carbonate, and ammonium bicarbonate.

In some embodiments the concentration of the sodium, potassium, or ammonium compound ranges from 0.5% to 5% by weight. In preferred embodiments, the concentration of the sodium, potassium, or ammonium compound ranges from 0.8% to 3% by weight.

Other objects, features and advantages of the present invention will become clear from the following description and drawings.

### BRIEF DESCRIPTION OF THE FIGURES

FIG. 1 is a graph of the mortality rate of engorged female ticks treated with various M. anisopliae spores-containing compositions.

FIG. 2 is a graph of the egg-laying rate of engorged female ticks treated with various M. anisopliae spores-containing compositions.

FIG. 3 is a graph of the rate of emergence of mycelia on cadavers of engorged female ticks treated with various M. anisopliae spores-containing compositions.

FIG. 4 is a graph showing the evolution of the tick population over time on cows treated with an M. anisopliae spores-containing composition or with a chemical insecticide.

FIG. 5 is a graph showing the effect of the number of treatments on the tick population over time on cows treated with an M. anisopliae spores-containing composition or with a chemical insecticide.

FIG. 6 is a graph of the mortality rate of engorged (dropped-off) female ticks placed in soil containers and treated with various compositions.

FIG. 7 is a graph of the egg-laying rate of engorged female ticks placed in soil containers and treated with various M. anisopliae spores-containing compositions.

FIG. 8 is a photograph showing the effect of the treatment of lice-infested cows with a M. anisopliae spores-containing compositions. A: before treatment. B: 1 day after treatment.

### DETAILED DESCRIPTION OF THE INVENTION

The present invention describes compositions comprising live spores of an entomopathogenic fungus suspended in oil in water emulsions. The components of the compositions have been selected for their insecticidal properties. In exemplary embodiments, the compositions are effective in controlling ticks.

The present invention now shows that the formulation of the compositions of the present invention is advantageous over hitherto known entomopathogenic compositions, providing highly effective insect control and at the same time being stable and harmless to vegetation and mammals.

According to one aspect, the present invention provides a composition comprising viable spores of at least one entomopathogenic fungus and an oil in water emulsion comprising at least one type of organic oil, at least one sodium, potassium, or ammonium salt of an organic fatty acid, at least one emulsifying agent, and at least one polyhydric alcohol.

The emulsions disclosed in the present invention are non-fungicidal, stable, and protect fungal spores from solar degradation, low humidity, and thermal stress. Furthermore, the compositions' components are biocompatible and can therefore be used to treat insect infestations in animals. The present invention further describes methods of producing and using said compositions.

As used herein, the term “emulsion” refers to a mixture of two immiscible liquids wherein one liquid forms a continuous phase within which droplets of the other liquid are dispersed in a discontinuous phase. In oil in water emulsions, droplets of oil are dispersed in the aqueous phase. In the context of the present invention the emulsion is capable of suspending the conidia of the entomopathogenic fungus. The oil component of the emulsion aids in suspension of the hydrophobic conidia and allows for high volume dispersion of the conidia of the fungus.

Within the scope of the present invention, a “biocompatible” composition has the property of not having toxic or injurious effects on an animal or a human subject.

The components of the compositions are described hereafter.

The term “oil” as used herein includes substances which are unctuous, viscous liquids at ordinary temperatures. Oils can be derived from either petroleum or from vegetables. According to the present invention the oil phase of the emulsion consists an oil selected from the group of organic oils that include, among others, olive oil, soya oil, corn oil, sunflower oil, canola oil, linseed oil, castor oil, fish oil, tung oil, sesame oil, and mixtures thereof. Tea tree oil is known to have fungicidal properties and is therefore not compatible with entomopathogenic fungi, which are the active component of the invention. Within the context of this invention, organic oils are substances derived from plants or animals that are composed of triglycerides. Middle chain triglyceride (MCT) oils can also be used as components of the emulsion. MCT oils are triglyceride oils in which the carbohydrate chain has 8-12 carbons, or a combination of two or three of such oils. MCT oil has many advantages over vegetable oils, amongst which are its lower susceptibility to oxidation, having a specific density of about 0.94-0.95 which is higher than that of vegetable oils and is closer to that of water, thus facilitating the formation of a stable emulsion. MCT oil is available commercially. Examples of such MCT oils include TCR (trade name of Societe Industrielle des Oleagineux, France, for a mixture of triglycerides wherein about 95% of the fatty acid chains have 8 or 10 carbons) and MYGLYOL 812 (trade name of Dynamit Nobel, Sweden, for a mixed triester of glycerin and of caprylic and capric acids). The oil used according to the teachings of the present invention is preferably selected from those that can protect entomopathogenic fungal conidia from harmful ultraviolet radiation, and do not adversely affect, or preferably enhance, conidia stability. Formulations which protect conidia from sunlight and high temperature damage are advantageous in increasing persistence of conidia after spraying on the animal body or in the field.

According to certain embodiments, the water phase of the emulsion consists of a polyhydric alcohol. As used herein, the term polyhydric alcohol refers to alcohol containing more than one hydroxyl group According to one embodiment, the polyhydric alcohol is selected from the group consisting of, but not limited to, glycerol, ethylene glycol, and propylene glycol. Typically, the alcohol used in the invention is glycerol.

Oil in water emulsions are stabilized by emulsifiers that coat the oil droplets dispersed in the aqueous phase to prevent droplet coalescence. Any emulsifier that does not interfere with the composition characteristics, particularly its biocompatible characteristic, can be used with the compositions of the present invention.

According to typical embodiments, the composition comprises a main emulsifier used to stabilize the emulsion. According to typical embodiments, the main emulsifier is a sodium, a potassium, or an ammonium salt of an organic fatty acid. Within the context of the present invention, an organic fatty acid is a medium to long-chain saturated or unsaturated monocarboxylic acids, usually having from 4 to 28 carbon atoms. The formation of said fatty acid salt occurs during the production of the emulsion, which is described hereafter. The fatty acids used in the emulsion are selected from the group consisting of, but not limited to, oleic acid, lauric acid, myristic acid, arachidic acid, linoleic acid, linolenic acid, decenoic acid, dodecenoic acid, tall oil fatty acids, naphthenic acids, stearic acid, and palmitic acid.

In addition to the main emulsifier, at least one other emulsifying agent selected from the group consisting of Triton X100, Tween 20, Tween 80, and lauryl amide is present in small amounts. In typical embodiments, at least two other emulsifying agents are used. In currently preferred embodiments, the additional emulsifying agents are Tween 20 and lauryl amide.

In some embodiments of the present invention, the emulsion further includes a dispersing additive. Its function is to improve the dispersion of the spores in the emulsion, reduce the viscosity of the emulsion, and reduce settling during storage. Any suitable dispersing agent as is known in the art can be used according to the teachings of the present invention. Suitable dispersion aids include for example, wetting agents, disintegrants, water soluble polymers, colloidal silica particles, sugars, mannitol and mixtures thereof. The currently preferred dispersing additive is BYK 980® (BYK Chemie, Wesel, Germany).

The oil concentration in the emulsion ranges from 12% to 30% by weight and from 15% to 25% by weight in preferred embodiments. The emulsifying agent or mixture of emulsifying agents is present in the emulsion at concentrations of 0.3% to 5% by weight. In preferred embodiments, the concentration ranges from 0.6% to 3% by weight. The polyhydric alcohol is present in the emulsion at concentrations of 8% to 30%. In preferred embodiments, the concentration ranges from 10% to 25% by weight.

The emulsion is produced in a process in which the fatty acid salt is formed by neutralizing the fatty acid with a sodium, a potassium, or an ammonium compound, such as sodium, potassium, or ammonium hydroxides, carbonates, or bicarbonates. An aqueous solution of the neutralizing compound is prepared in a first container. The organic oil and organic fatty acid components of the emulsions are mixed in a separate container and stirred until an homogeneous mixture is obtained. The content of the first container is then admixed with the oil/fatty acid homogenate. The polyhydric alcohol and the emulsifying agent are then added. If desired, the dispersive additive is also added at this stage. The order of addition of the alcohol, emulsifying agent and dispersive additive is not critical. The resulting composition is mixed with a mixer for a period of time and a rotation speed sufficient to ensure the formation of a stable emulsion.

The active insecticidal agent of the composition is an entomopathogenic fungus. As used herein, the term “entomopathogenic fungus” means a fungus which is capable of killing an insect. Such a fungus is considered a mycopesticide. Entomopathogenic fungi include those strains or isolates of fungal species in the class Deuteromycetes (imperfect fungi) which possess characteristics allowing them to be virulent against insects, particularly ticks. These characteristics include formation of stable infective conidia. An effective entomopathogenic fungus preferably is lethal for target insects but less harmful for non-target insects. Also, the entomopathogenic fungus preferably does not harm vegetation or animals that might come in contact with it.

Examples of entomopathogenic fungi include Metarhizium anisopliae, Beauveria bassiana, Verticillium and Paecilomyces species. The most effective entomopathogenic fungi against ticks are Metarhizium anisopliae and Beauveria bassiana.

In one embodiment of the present invention, the insecticidal composition comprises spores of Metarhizium anisopliae. The spores of two specific strains of Metarhizium anisopliae strain Ma7 and strain MITM1, are used in most preferred embodiments. Strain MITM1 of the entomopathogenic fungus Metarhizium anisopliae has been deposited at the ATCC under accession number ______.

The main targets of the biocontrol compositions disclosed in the present invention are ticks (order Acarina). Other insects that are controlled or killed include beetles (order Coleoptera), fleas (order Siphonaptera), mites (order Acarina), and lice (orders Anoplura and Mallophaga). Cockroaches, ants, termites, flies, wasps, mealworms, wax moths, corn root worms, and other harmful insects may also be controlled by the composition.

Spores can be produced by any of the standard procedures such as culturing of the fungi on standard agar-based nutritive media formulations, solid state (substrate) fermentations on nutritive sources such as rice, barley, wheat, corn, other cereal grains or straw, and submerged fermentation. The purified spores can be either used immediately (for example, post harvest) or recovered from ambient, humidified or dry storage conditions and suspended in water containing a small amount of surfactant (for example 0.01% Triton X100 in water), oil or any mixture and combination thereof as required for preparation of the composition.

The composition can be formulated in multiple forms, for example as a dust, wettable powder, sprayable emulsion, paste or shampoo. The form will be chosen according to criteria such as for example, the kind of insect infestation to be treated, the kind and the number of animals to which it is to be applied, or the size of the treated geographical area. For example, a paste or shampoo may be preferred to treat a companion animal such as a cat or a dog. Emulsions applied with hand-held sprayers and race sprayers may be used to treat livestock as well as the animal's environment. Hand application of dusts or pastes may be convenient to treat a localized infestation, for example in the ear of an animal. To treat larger geographical areas such as pastures and crop fields, spraying an emulsion from an airplane would be the most satisfying solution.

The components of the composition (i.e., the spores and the emulsion) may be provided in a kit, contained in a single container or preferably in separate containers. The user can choose to mix the components to make the composition extemporaneously to the application, or he may choose to mix the components to make the composition substantially prior to the application, and store the composition for a period of time that does not affect the stability and infectivity of the composition until application.

The utility of the compositions can be observed in laboratory bioassays and field experiments.

In laboratory bioassays, compositions comprising spores of Metarhizium anisopliae strain Ma7 and MITM1 achieve a higher tick mortality rate than previously known fungal-based treatments. A 100% mortality rate is achieved within 3-4 days by treating ticks with the composition, compared to 10 days needed to achieve the same mortality rate with spores suspended in water. Moreover, ticks treated with the composition are unable to lay fertile eggs or to lay eggs at all, whereas ticks treated with the spore suspended in water lay eggs at almost the same rate as untreated ticks. Likewise, mycelia develop faster in ticks treated with the composition than in ticks treated with the spore suspended in water. Speeding up fungi sporulation and mycelium appearance on the cadavers provides an efficient tool to prevent egg laying and thus control the life cycle of the tick. The ability of infected cadavers to infect healthy ticks in the animal's environment may be of critical importance in terms of reducing the tick population.

When topically administered to cows, the suspension controls ticks as effectively as a chemical insecticide and remains active for a longer period of time. Importantly, fewer applications of the composition are needed to control the tick population over a specific period of time. When used to treat a lice infestation in cows, the compositions of the present invention produce better results than a chemical insecticide. The compositions of the present invention are also highly effective in killing ticks dropped of from an animal.

The present invention will now be illustrated by the following examples which are intended to be construed in a non-limitative fashion.

### EXAMPLES

### Example 1

### Preparation of an Oil in Water Emulsion

To obtain 1 liter of emulsion, 6.45 grams of sodium carbonate were dissolved in 473.55 grams of water in a first container. In a second container, 100 grams of canola oil and 100 grams of oleic acid were mixed until a homogeneous mixture was obtained. The salt solution was then admixed with the oil mixture. To the obtained mixture 300 grams of glycerol, 10 grams of lauryl amide, and 10 grams of Tween 20 were added. The pH of the resulted composition was adjusted to approximately 7 with a few drops of hydrochloric acid, and the composition was emulsified in a mixer at 600 rpm for 3 hours.

### Example 2

### Efficiency of M. Anisopliae Compositions in Bioassays

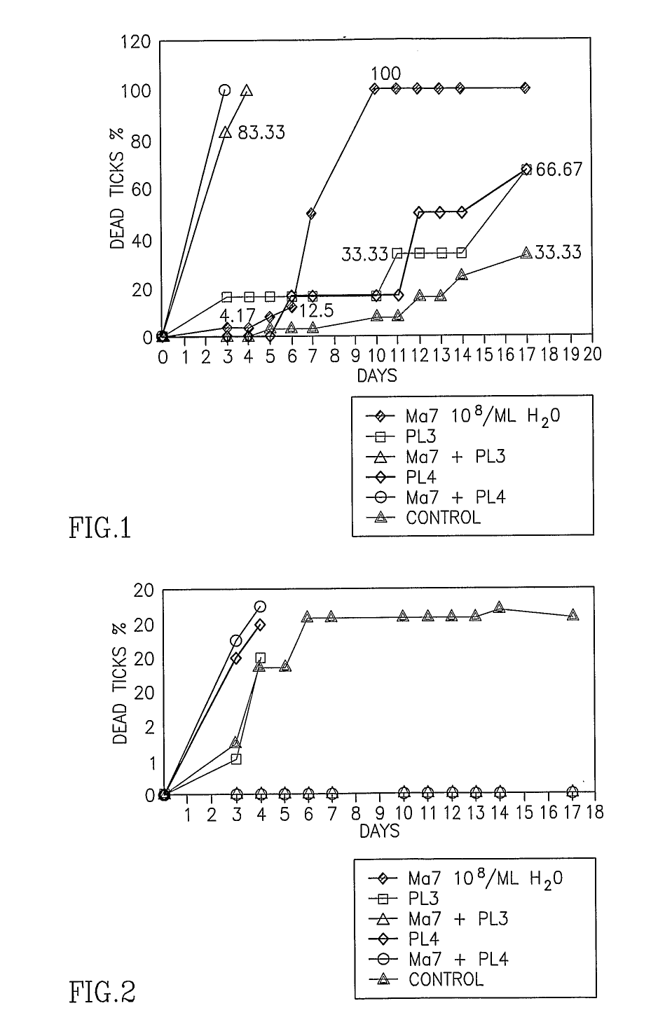

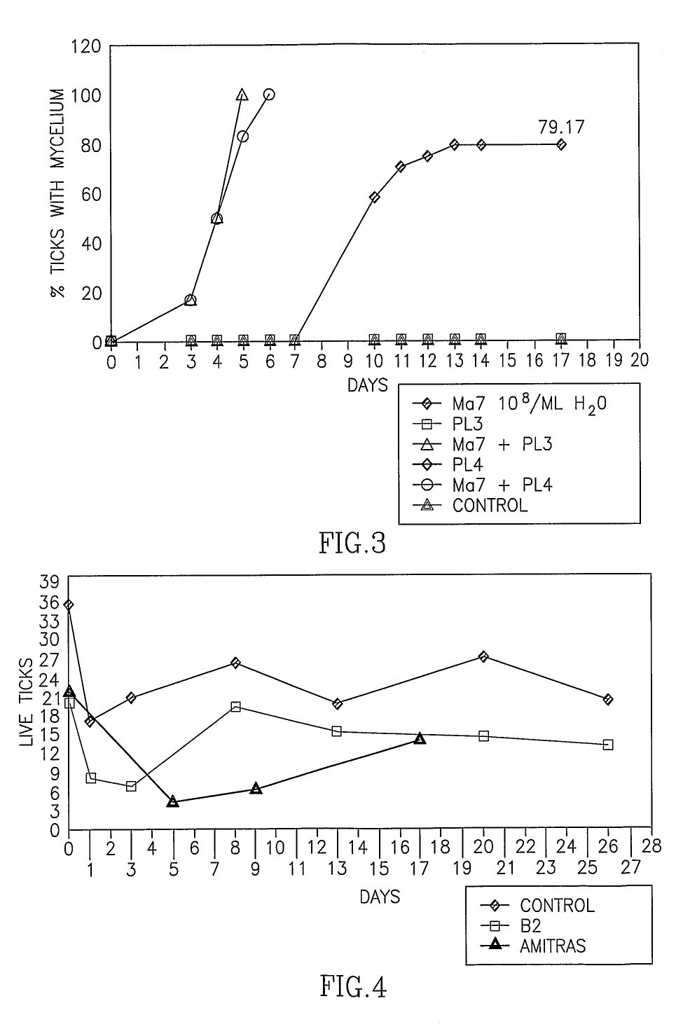

Boophilus annulatus engorged female ticks were immersed in different compositions and the mortality rate (FIG. 1), egg-laying rate (FIG. 2), and rate of appearance of mycelia on ticks cadavers (FIG. 3) was measured.

The following treatments were used (the emulsion formulation is described in Table 1 herein below):

PL-3+: 1×10⁸ spores/ml of M. anisopliae Ma7 in a 5% PL3 emulsion.

PL-4+: 1×10⁸ spores/ml of M. anisopliae Ma7 in a 5% PL4 emulsion.

PL-3−: 5% PL3 emulsion without fungal spores.

PL-4−: 5% PL4 emulsion without fungal spores.

Ma7: 1×10⁸ spores/ml of M anisopliae suspended in water.

Control: no treatment.

A 100% mortality rate was achieved after 3-4 days with the PL3+ and PL4+ compositions, an effect achieved by the composition of M. anisopliae spores in water after 10 days. The PL3+ and PL4+ compositions completely prevented egg laying by the ticks, whereas treatment with M. anisopliae spores in water did not have this preventive effect. Mycelia appeared on the cadavers of ticks treated with the PL3+ and PL4+ compositions within 5-6 days, as compared to 13 days for ticks treated with M. anisopliae spores in water.

TABLE 1
Emulsion formulations PL-3 and PL-4

Amount (%, weight)

| Ingredient | PL-3 | PL-4 |
|---|---|---|
| H₂O | 48.40 | 42.30 |
| Canola Oil | 24.20 | 20.00 |
| Glycerin | 20.00 | 30.00 |
| Oleic acid | 4.8 | 5.05 |
| TritonX100/Tween 20 | 0.97 | 1.00 |
| Lauryl amide | 0.97 | 1.00 |
| NaOH | 0.65 | 0.65 |
| Total | 100.00 | 100.00 |

### Example 3

### Comparison of the Efficiency of an M. Anisopliae Composition and a Chemical Insecticide for Tick Control on Cows

The experiment included 13 cows divided to three groups as follows:

Four cows received no treatment and served as a control; four cows were treated with 0.2% of the acaricide Amitraz; and five cows were treated with the M. anisopliae in composition B2 described in Table 2 herein below. The results show that the chemical insecticide Amitraz and composition B2 both reduced the tick population compared to the untreated controls (FIG. 4). However, Amitraz becomes inactive after 5 days, allowing tick population growth thereafter. Composition B2 remains active well beyond Amitraz's efficiency.

TABLE 2
Emulation formulation B2

| Ingredient | Amount (%, weight) |
|---|---|
| H₂O | 47.90 |
| Canola oil | 23.96 |
| Glycerol | 16.00 |
| BYK980 | 4.79 |
| Oleic acid | 4.79 |
| Lauryl amide | 0.96 |
| Tween 20 | 0.96 |
| NaOH | 0.64 |
| Total | 100.00 |

### Example 4

### Long Term Effects of M. Anisopliae Spores Composition and a Chemical Insecticide on Tick Control on Cows

The experiment included 119 cows, which were divided in two groups as follows:

Thirty cows were treated with the M. anisopliae in composition B25 (Table 3 herein below). Eighty-eight cows were treated with the insecticide Cyhalothrin.

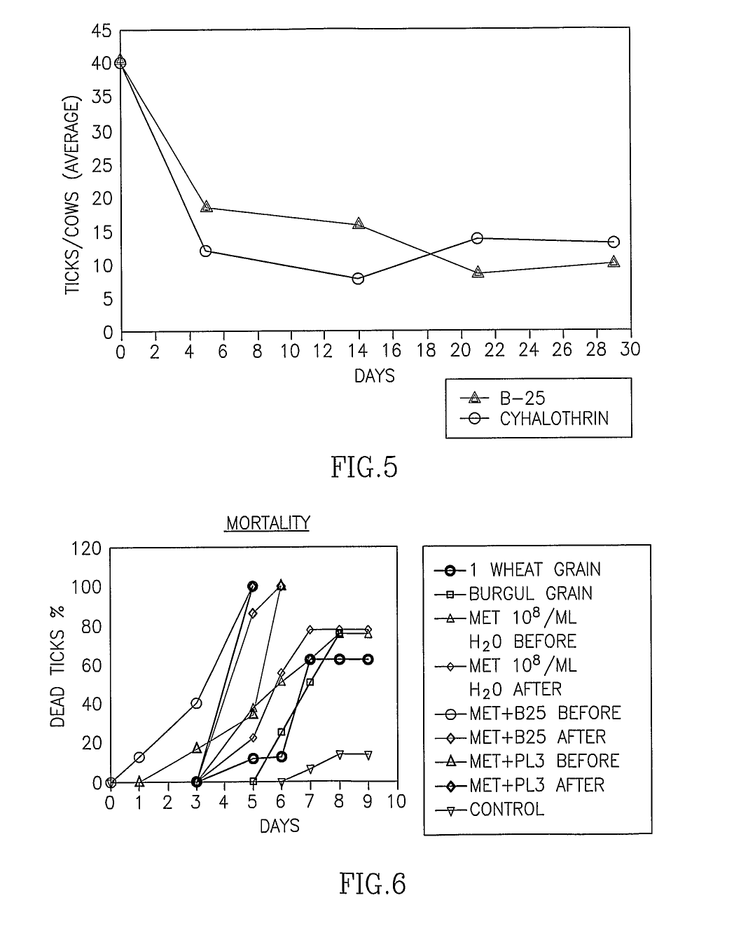

Composition B25 was sprayed on the cow's skin at the beginning of the experiment (day 0) and two weeks later (day 14). The synthetic insecticide Cyhalothrin was sprayed on the cows at the beginning of the experiment (day 0) and thereafter two more treatments were given at one week interval, i.e. at the 7^{th} and 14^{th} day (FIG. 5).

Although the number of ticks on the cows was not significantly different in the two treatments, a continues decrease in the number of ticks on cows treated with composition B25 of the present invention was observed until day 22, while an increase in the number of ticks on cows treated with Cyhalothrin was observed immediately after the second treatment at day 14.

TABLE 3
Emulation formulation B25

| Ingredient | Amount (%, weight) |
|---|---|
| H₂O | 47.55 |
| Canola Oil | 20.00 |
| Glycerin | 20.00 |
| Oleic acid | 5.00 |
| BYK980 | 4.80 |
| Lauryl amide | 1.00 |
| Tween 80 | 1.00 |
| NaOH | 0.65 |
| Total | 100.00 |

### Example 5

### Effect of M. Anisopliae Compositions on Engorged Dropped-of Female Ticks

The experiment was conducted as a simulation of natural field condition, by imitating the hiding places of engorged female ticks dropped off from their host.

Five containers in the size of 17×28×15 cm each, were divided in the middle by a screen, filled with soil, stones and leaves from the pasture and placed in the pasture in a dig 15 cm deep.

100 engorged female ticks were placed in the containers sections at a rate of 10 ticks per section.

The sections were treated as follows: 1. Metarhizium anisopliae (M.a) on wheat grains as a growing media.

2. Metarhizium anisopliae (M.a) on crushed wheat grain (Burgul grains) as a growing media.

3. PL-3—Combined product: Fungus, Metarhizium anisopliae (Met), 1×10⁸ spores/ml in 5% PL-3 formulation described hereinabove.

4. B-25—Combined product: Fungus, Metarhizium anisopliae (Met), 1×10⁸ spores/ml in 5% B-25 formulation described herein above.

5. One container (2 sections) was left untreated as a control.

6. Metarhizium anisopliae (Met), 1×10⁸ spores/ml in water.

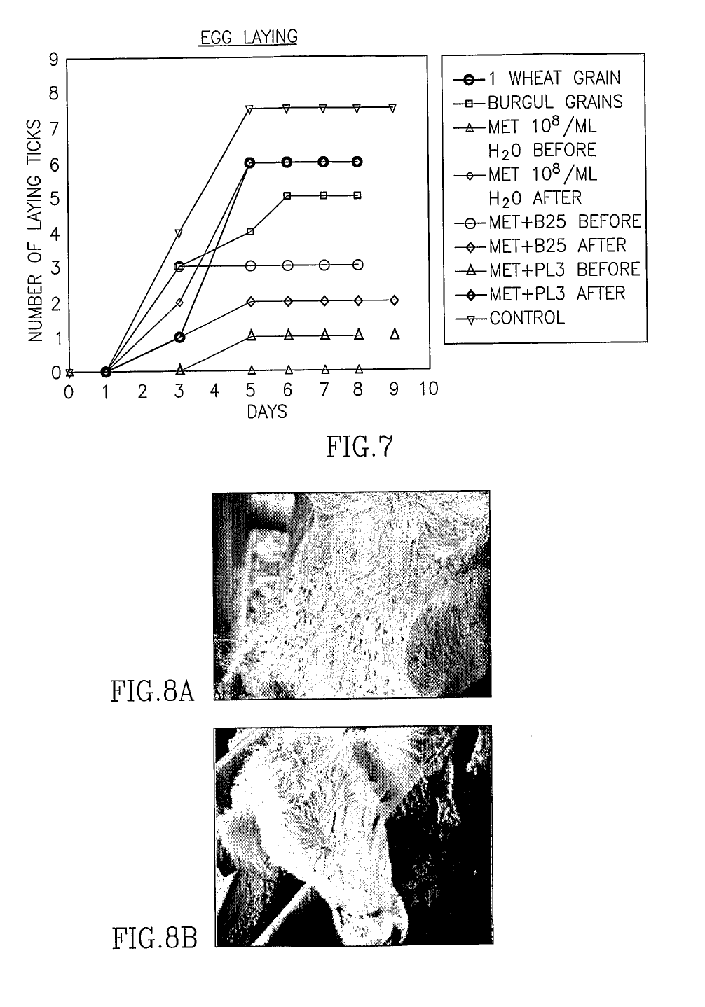

In each section treating/spraying of the ground was performed before or after the ticks were placed, as indicated in FIGS. 6-7.

100% mortality was obtained only with the compositions of the present invention, i.e. M. anisopliae spores in PL-3 or B25 composition, at a maximum of 5 days post treatment (FIG. 6). These treatments were also most efficient in preventing egg laying. Fungi mycelium was detected on the ticks within 12 days.

The mortality rate of the ticks treated only with the fungus (Met 1×10⁸/ml of water) reached only 80%, and after only after 7-8 days (depending on the treatment timing) with about 68% percent of the ticks laying eggs.

When no treatment was applied to the container filling (control), 100% of the control ticks were found to be living 6 days from the beginning of the trial. Only 10% of the ticks died until day 10 of the experiment, and 75% of them laid eggs.

### Example 6

### Effect of M. Anisopliae Compositions on Lice Present on Cows

A lice infestation in a cattle farm was treated with an M. anisopliae composition (M. anisopliae in PL-3), and compared to a treatment with the chemical insecticide Amitraz. The M. anisopliae composition gave better results than Amitraz. The lice disappeared from the animals within one day of treatment (FIG. 8). A second treatment was given one week later when new lice emerged from the eggs. Again the M. anisopliae composition gave better results.

1-60. (canceled)

61. An insecticidal composition comprising viable spores of at least one entomopathogenic fungus, and an oil in water emulsion comprising:
(a) at least one organic oil;
(b) at least one sodium, potassium, or ammonium salt of an organic fatty acid;
(c) at least one emulsifying agent; and
(d) at least one polyhydric alcohol.

62. The composition according to claim 61, wherein the oil is selected from the group consisting of: olive oil, soy oil, corn oil, sunflower oil, canola oil, linseed oil, castor oil, fish oil, tung oil, sesame oil, and Middle chain triglyceride (MCT) oils.

63. The composition according to claim 61, wherein the oil concentration is in the range of from 12% to 30% by weight or from 15% to 25% by weight.

64. The composition according to claim 61, wherein the organic fatty acid is selected from the group consisting of: oleic acid, lauric acid, myristic acid, arachidic acid, linoleic acid, linolenic acid, decenoic acid, dodecenoic acid, tall oil fatty acids, naphthenic acids, stearic acid, and palmitic acid.

65. The composition according to claim 61, wherein the emulsifying agent is selected from the group consisting of: Triton X100, Tween 20, Tween 80, and lauryl amide.

66. The composition according to claim 61, comprising at least two emulsifying agents.

67. The composition according to claim 66, wherein the emulsifying agent is a mixture of Tween 20 and lauryl amide.

68. The composition according to claim 61, wherein the concentration of the emulsifying agent is in the range of from 0.3% to 5% by weight or from 0.6% to 3% by weight.

69. The composition according to claim 61, wherein the polyhydric alcohol is selected from the group consisting of: ethylene glycol, propylene glycol, and glycerol.

70. The composition according to claim 61, wherein the concentration of the polyhydric alcohol is in the range of from 8% to 30% by weight, or from 10% to 25% by weight.

71. The composition according to claim 61, further comprising a dispersing additive.

72. The composition according to claim 71, wherein the dispersing additive is BYK 980.

73. The composition according to claim 61, wherein the entomopathogenic fungus is selected from the group consisting of Metarhizium anisopliae and Beauveria bassiana.

74. The composition according to claim 73, wherein the fungus is Metarhizium anisopliae strain MITM1.

75. A method for preventing or treating an insect infestation comprising applying an effective amount of an insecticidal composition comprising as a first component viable spores of at least one entomopathogenic fungus and as a second component an oil in water emulsion comprising:
(a) at least one organic oil;
(b) at least one sodium, potassium, or ammonium salt of an organic fatty acid;
(c) at least one emulsifying agent; and
(d) at least one polyhydric alcohol.

76. The method according to claim 75, wherein the composition is applied topically to an animal.

77. The method according to claim 75, wherein the composition is applied to the environment of an animal.

78. The method according to claim 75, wherein the composition comprises oil selected from the group consisting of: olive oil, soy oil, corn oil, sunflower oil, canola oil, linseed oil, castor oil, fish oil, tung oil, sesame oil, and (Middle chain triglyceride) MCT oils.

79. The method according to claim 75, wherein the oil concentration is in the range of from 12% to 30% by weight or from 15% to 25% by weight.

80. The method according to claim 75, wherein the composition comprises organic fatty acid selected from the group consisting of: oleic acid, lauric acid, myristic acid, arachidic acid, linoleic acid, linolenic acid, decenoic acid, dodecenoic acid, tall oil fatty acids, naphthenic acids, stearic acid, and palmitic acid.

81. The method according to claim 75, wherein the composition comprises an emulsifying agent selected from the group consisting of: Triton X100, Tween 20, Tween 80, and lauryl amide.

82. The method according to claim 75, wherein the composition comprises at least two emulsifying agents.

83. The method according to claim 82, wherein the emulsifying agent is a mixture of Tween 20 and lauryl amide.

84. The method according to claim 75, wherein the concentration of the emulsifying agent is in the range of from 0.3% to 5% by weight or from 0.6% to 3% by weight.

85. The method according to claim 75, wherein the composition comprises polyhydric alcohol selected from the group consisting of: ethylene glycol, propylene glycol, and glycerol.

86. The method according to claim 85, wherein the polyhydric alcohol is glycerol.

87. The method according to claim 75, wherein the concentration of the polyhydric alcohol is in the range of from 8% to 30% by weight or of from 10% to 25% by weight.

88. The method according to claim 75, wherein the composition further comprises a dispersing additive.

89. The method according to claim 88, wherein the dispersing additive is BYK 980.

90. The method according to claim 75, wherein the composition comprises entomopathogenic fungus selected from the group consisting of: Metarhizium anisopliae and Beauveria bassiana.

91. The method according to claim 90, wherein the fungus is Metarhizium anisopliae strain MITM1.

92. The method according to claim 75, wherein the composition is formulated as a veterinary formulation selected from the group consisting of: sprayable emulsions, suspensions, powders, pastes, and shampoos.

93. The method according to claim 75, wherein the mode of application of the formulation is selected from the group consisting of: manual application, application by hand-held sprayer, application by race sprayer, application by tank sprayer, application by airplane spraying.

94. The method according to claim 75, wherein the insect infestation is selected from the group consisting of a tick (order Acarina), a beetle (order Coleoptera), a flea (order Siphonaptera), a mite (order Acarina), and a louse (orders Anoplura and Mallophaga) infestation.

95. The method according to claim 94, wherein the insect infestation is a tick infestation.

96. A kit for preventing or treating an insect infestation comprising: packaging material, an effective amount of viable spores of an entomopathogenic fungus, and an oil in water emulsion comprising:
(a) at least one organic oil;
(b) at least one sodium, potassium, or ammonium salt of an organic fatty acid;
(c) at least one emulsifying agent; and
(d) at least one polyhydric alcohol.

97. The kit according to claim 96, wherein the entomopathogenic fungus is selected from the group consisting of: Metarhizium anisopliae and Beauveria bassiana.

98. The kit according to claim 97, wherein the fungus is Metarhizium anisopliae strain MITM1.

99. The kit according to claim 96, wherein each of the spores and the oil in water emulsion is packed in a separate container.

100. The kit according to claim 96, wherein the spores and the composition are packed in a single container.

101. The kit according to claim 96, wherein the insect infestation is selected from the group consisting of a tick (order Acarina), a beetle (order Coleoptera), a flea (order Siphonaptera), a mite (order Acarina), or a louse (orders Anoplura and Mallophaga) infestation.

102. The kit according to claim 101, wherein the insect infestation is a tick infestation.

103. The kit of claim 96, wherein the oil in water emulsion further comprises a dispersing additive.

104. A composition in the form of an oil in water emulsion comprising:
(a) at least one organic oil;
(b) at least one organic fatty acid salt;
(c) at least one emulsifying agent; and
(d) at least one polyhydric alcohol.

105. The composition according to claim 104, further comprising a dispersing additive.

106. A method of producing a composition in the form of an oil in water emulsion comprising:
(a) at least one organic oil;
(b) at least one sodium, potassium, or ammonium salt of an organic fatty acid;
(c) at least one emulsifying agent; and
(d) at least one polyhydric alcohol comprising the steps of:
(i) admixing an aqueous solution of a sodium, potassium, or ammonium compound with a mixture of an organic fatty acid and an organic oil;
(ii) adding a polyhydric alcohol and an emulsifying agent to the composition obtained in step (i);
(iii) mixing until an oil in water emulsion is obtained.

107. The method according to claim 106, wherein the sodium, potassium, or ammonium compound is selected from the group consisting of: sodium hydroxide, potassium hydroxide, sodium carbonate, potassium carbonate, sodium bicarbonate, potassium bicarbonate, ammonium hydroxide, ammonium carbonate, and ammonium bicarbonate.

108. The method according to claim 106, wherein the concentration of the sodium, potassium, or ammonium compound ranges from 0.5% to 5% by weight or from 0.8% to 3% by weight.

109. The method according to claim 106, wherein step (i) further comprises adding a dispersing additive.

110. The method according to claim 109, wherein the dispersing additive is BYK 980.
